(19) United States
(12) Patent Application Publication
(10) Pub. No.: US 2024/0263019 A1
(43) Pub. Date: Aug. 8, 2024

(54) EASILY RECYCLABLE PIGMENTED PULVERULENT COMPOSITION FOR COATING SUBSTRATES

(71) Applicant: ARKEMA FRANCE, Colombes (FR)

(72) Inventors: Jean-Yves LOZE, Serquigny (FR); Pierrick ROGER-DALBERT, Pierre-Benite Cedex (FR)

(73) Assignee: ARKEMA FRANCE, Colombes (FR)

(21) Appl. No.: 18/248,263

(22) PCT Filed: Oct. 8, 2021
(86) PCT No.: PCT/FR2021/051760

§ 371 Date: Apr. 7, 2023

(30) Foreign Application Priority Data
Oct. 9, 2020 (FR) FR2010336

(51) Int. Cl. C09D 5/03; B05D 1/06; C08J 3/12; C08J 3/20; C08J 3/24; C08K 3/013; C09D 7/80; C09D 177/02

(52) U.S. Cl. CPC C09D 5/035; B05D 1/06; C08J 3/12; C08J 3/201; C08J 3/247; C08K 3/013; C09D 7/80; C09D 177/02; B05D 2202/00; C08J 2377/02

(57) ABSTRACT

A pigmented pulverulent composition based on polyamide for coating substrates, including: (a) 40% to 99% by weight of at least one polyamide, (b) 1% to 30% by weight of at least one pigment, and (c) 0% to 30% by weight of at least one additive, wherein the polyamide has an inherent viscosity, as measured using an Ubbelohde tube at 20° C. on a 0.5% by weight solution in m-cresol according to standard ISO 307 but with a measuring temperature of 20° C. rather than 25° C., of more than 0.7 (g/100 g)−1, and wherein the composition has a volume-median diameter Dv50, as measured according to standard ISO 9276—parts 1 to 6, of 10 to 200 μm. A process for manufacturing the composition, the use thereof for coating a—metallic—substrate, and an object comprising a metallic substrate coated with a coating obtained with the pigmented pulverulent composition based on polyamide.

### TECHNICAL FIELD

The present patent application concerns a pigmented pulverulent composition for coating substrates which is easily recyclable. It also concerns a process for manufacturing such a composition, the use of this composition for coating substrates, especially metallic substrates, and the objects obtainable that are coated with a coating.

### PRIOR ART

The use of polymer powders for manufacturing coatings for substrates, especially metallic substrates, is known. These powders are formulated on the basis of a resin, one or more pigments and specific additives such as plasticizers, stabilizers or flow control agents.

The pulverulent composition is applied to the substrate in the form of a free powder, by electrostatic spraying or by immersion of the substrate in a fluidized bed of powder, for example, and so does not require any solvent or binder. The polymers used for manufacturing powders are commonly thermosetting resins, though it is also possible to use thermoplastic polymers.

Owing to their high chemical and thermal resistance, polyamides are polymers of choice for demanding applications, such as the coating on dishwasher baskets, for example.

The pulverulent composition for coating substrates may be manufactured by various processes.

It is possible to dry-mix the one or more pigments and the optional additives with the polymer powder. However, these powders are not easily recyclable. The reason is that the fraction of powder that fails to reach the substrate during spraying, referred to as overspray, which it is advantageous to recover for recycling, generally does not have the same composition as the powder initially employed, and the coatings obtained from the recycled overspray hence do not correspond to said powder in terms of appearance and properties.

Application WO 2012/034507 A1 describes a process in which the pigments and optional additives are premixed and then melt-mixed with polymer. The melt mixture is then cooled, pelletized and ground to give a powder. This process yields satisfactory results for a variety of polymers. However, the polyamide grades suitable for producing powder coatings are too ductile to be amenable to grinding at ambient temperature. They can be ground at low temperature by cryogenic grinding, but at some cost and with a low yield. The resultant powders are not very rounded and may therefore be more difficult to use, in particular forming clouds of irregular charged particles because of increased friction.

It is also known practice, from U.S. Pat. No. 5,932,687 for example, to manufacture a polyamide powder by hot dissolution in a solvent such as ethanol, and precipitation in powder form by cooling. This process requires large quantities of solvent and may produce particles which are porous.

Furthermore, incorporating pigments by adding them to the solution is possible only for limited amounts and may cause difficulties due to their inherent nucleating effect.

Document U.S. Pat. No. 3,476,711 proposes grinding a low-viscosity polyamide and then heating it in inert gas to cause its viscosity to rise to the desired value. But this document says nothing about the problem of incorporating pigments and additives into the polyamide powder.

### SUMMARY OF THE INVENTION

It is thus an aim of the invention to provide a process for manufacturing a pigmented pulverulent composition based on polyamide for coating substrates based on polyamide which has an appearance, especially in terms of colour and gloss, and properties, especially mechanical properties, which are unaltered even after recycling, while being inexpensive.

The present invention, indeed, lies in the finding that an easily recyclable pigmented pulverulent composition based on polyamide may be obtained by incorporating the pigment or pigments into the polyamide of low viscosity in the melted state, the mixture then being crushed and ground before undergoing a heat treatment step for attaining the target viscosity of the polyamide.

The resultant pulverulent composition exhibits a uniform distribution of the one or more pigments and additives in each particle. It is therefore possible to ensure a stability in the appearance, especially the color, and in universal performance properties, including after recycling.

Therefore, according to a first aspect, one subject of the invention is a pigmented pulverulent composition based on polyamide for coating substrates, comprising:
(a) 40% to 99% by weight of at least one polyamide,
(b) 1% to 30% by weight of at least one pigment, and
(c) 0% to 30% by weight of at least one additive,

wherein the polyamide has an inherent viscosity, as measured using an Ubbelohde tube at 20° C. on a 0.5% by weight solution in m-cresol according to standard ISO 307 but with a measuring temperature of 20° C. rather than 25° C., of more than 0.7 (g/100 g)⁻¹, and wherein the composition has a volume-median diameter Dv50, as measured according to standard ISO 9276—parts 1 to 6, of 30 to 200 μm, preferably 30 to 50 μm.

According to one embodiment, the polyamide is selected from PA 9, PA 10, PA 11, PA 12, PA 610, PA 612, PA 614, PA 618, PA 1010 and PA 1012. According to one embodiment, the polyamide is a polyamide 11.

According to one embodiment, the pigment is selected from titanium dioxide, carbon black, cobalt oxide, nickel titanate, molybdenum bisulfide, aluminum flakes, iron oxides, zinc oxide, zinc phosphate, and organic pigments, such as phthalocyanine and anthraquinone derivatives.

According to one embodiment, the composition comprises 50% to 95% by weight of at least one polyamide.

According to one embodiment, the composition comprises 1% to 30% by weight of at least one additive selected from anti-crater agents, spreading agents, reducing agents, antioxidants, reinforcing fillers, UV stabilizers, fluidizing agents and corrosion inhibitors.

According to one embodiment, the polyamide has an inherent viscosity, as measured using an Ubbelohde tube at 20° C. on a 0.5% by weight solution in m-cresol according to standard ISO 307 but with a measuring temperature of 20° C. rather than 25° C., of less than 1.0 (g/100 g)⁻¹.

According to a second aspect, another subject of the invention is a process for manufacturing a pigmented pulverulent composition of this kind, comprising the steps of:
(i) mixing one or more pigments and optional additives with a polyamide in the melted state, the polyamide having an inherent viscosity of less than 0.6 (g/100 g)⁻¹;
(ii) extruding the mixture obtained in step (i) to give an extrudate;
(iii) grinding the extrudate obtained in step (ii) to give a pulverulent composition; and
(iv) performing solid-phase polycondensation of the pulverulent composition obtained in step (iii) until the polyamide in the composition has an inherent viscosity of more than 0.8 (g/100 g)⁻¹.

According to one embodiment, the polyamide used in step (i) has an inherent viscosity of less than 0.4 (g/100 g)⁻¹.

According to one embodiment, step (ii) is carried out in a single-screw extruder or a twin-screw extruder.

According to one embodiment, step (iv) is carried out in a drier.

According to a third aspect, another subject of the invention is the use of such a composition for coating a substrate, especially a metallic substrate.

According to one embodiment, the coating is carried out by electrostatic spraying or hot powder coating.

According to a fourth aspect, lastly, another subject of the invention is an object comprising a metallic substrate coated with a coating obtained with a pigmented pulverulent composition of this kind.

According to one embodiment, the object is a piping, an accessory, a pump or a valve, a splined shaft, a sliding door rail or springs, especially of truck damper or automobile seat type, and especially therefore parts used in automobile construction, or else a dishwasher basket or springs.

### DESCRIPTION OF THE EMBODIMENTS

### Definition of the Terms

The term “inherent viscosity” refers to the viscosity of a polymer in solution, determined via measurements in an Ubbelohde tube. The measurement is carried out on a 75 mg sample at a concentration of 0.5% (m/m) in m-cresol. The inherent viscosity, expressed in (g/100 g)⁻¹, is calculated according to the following formula: Inherent viscosity=In(ts/to)×1/C, with C=m/p×100, in which ts is the flow time of the solution, to is the flow time of the solvent, m is the mass of the sample whose viscosity is being determined, and p is the mass of the solvent. This measurement is carried out according to standard ISO 307 but with a measuring temperature of 20° C. rather than 25° C. The viscosity of a composition comprising the polymer plus pigments and any fillers insoluble in m-cresol is determined by increasing the sample quantity so that the solution has a polymer concentration of 0.5% (m/m).

The term “melting point” is understood to denote the temperature at which an at least partially crystalline polymer passes into the viscous liquid state, as measured by differential scanning calorimetry (DSC) according to standard NF EN ISO 11357-3 using a heating rate of 20° C./min.

The term “glass transition temperature” is understood to denote the temperature at which an at least partially amorphous polymer passes from a rubbery state into a glassy state, or vice versa, as measured by differential scanning calorimetry (DSC) according to standard NF EN ISO 11357-2 using a heating rate of 20° C./min.

The term “polyamide” is understood to denote the polycondensation products of lactam(s), of aminocarboxylic acid(s) or of dicarboxylic acid(s) and diamine(s), and, generally, any polymer formed of units interconnected by amide functions.

In the sense of the present patent application, the term “monomer” should be taken with the meaning of “repeat unit”. This is because the case where a repeat unit of the polyamide (PA) consists of the combination of a diacid with a diamine is particular. It is considered that it is the combination of a diamine and of a diacid, that is to say the diamine-diacid pair (in an equimolar amount), which corresponds to the monomer. This is explained by the fact that, individually, the diacid or the diamine is only a structural unit, which is not enough in itself alone to be polymerized.

In the present patent application, the expression “based on polyamide” or “polyamide-based” should be understood as meaning “based on one or more polyamides”. This is likewise the case for the other components (for example, the term “a pigment” should be understood as meaning “one or more pigments”).

Furthermore, the term “volume-average diameter” or “Dv” refers to the volume-average diameter of a pulverulent substance, as measured according to standard ISO 9276—parts 1 to 6:

“Representation of results of particle size analysis”. Various diameters are differentiated. More specifically, the Dv50 denotes the volume-median diameter, being that corresponding to the 50^{th} volume percentile, and the Dv10 and Dv90 denote respectively the volume-average diameters below which are located 10% or 90% by volume of the particles. The volume-average diameter may be measured especially by means of a laser granulometer, as for example a laser granulometer (Malvern Système Insitec). Associated software (RT sizer) can then be used to obtain the volumetric distribution of a powder and deduce therefrom the Dv10, the Dv50 and the Dv90.

In the absence of any indication to the contrary, all of the percentages concerning the quantities mentioned in the present specification are understood to be percentages by mass.

### A. Pigmented Pulverulent Composition

In a first aspect, the invention concerns a pigmented pulverulent composition based on polyamide and intended to form a coating on a substrate.

The one or more polyamides that are of interest for this pulverulent composition may in principle be selected from among the multitude of polyamides available on the market.

Preferably, however, the polyamides involved are semicrystalline polyamides, especially linear aliphatic polyamides, and more particularly polyamides obtained from monomers containing 9 or more, preferably 10 or more, carbon atoms.

The amino acid monomers include α,Ω-aminocarboxylic acids having from 6 to 18 carbon atoms such as aminocaproic acid, 7-heptanoic, 9-aminononanoic, 10-aminodecanoic and 11-aminoundecanoic acid and 12-aminododecanoic acid. The α,Ω-aminocarboxylic acids having from 9 to 18 carbon atoms such as 11-aminoundecanoic acid and 12-aminododecanoic acid are preferred.

The “diamine-diacid” monomers are obtained from the condensation of a dicarboxylic acid with a diamine.

Examples of dicarboxylic acids include the acids having from 6 to 36, especially 8 to 18 and more particularly 10 to 12 carbon atoms. The diacids may be aliphatic, cycloaliphatic or aromatic diacids.

They include, for example, adipic acid, azelaic acid, suberic acid, sebacic acid, dodecanedioic acid HOOC—(CH₂)₁₀—COOH, tetradecanedioic acid, isophthalic acid and terephthalic acid. Aliphatic diacids, more particularly linear aliphatic diacids such as sebacic acid and dodecanedioic acid, are preferred. Examples of diamines include the diamines having 2 to 36, preferably 4 to 18, carbon atoms. They may be aromatic, aliphatic or cycloaliphatic. Included, for example, are 1,4-tetramethylenediamine, 1,6-hexamethylenediamine, 1,8-octamethylenediamine, 1,10-decamethylenediamine and 1,12-dodecamethylenediamine, m-xylylenediamine, bis-p-aminocyclohexylmethane and trimethylhexamethylenediamine.

Examples of diamine-diacids include more particularly those obtained from the condensation of 1,6-hexamethylenediamine or 1,10-decamethylenediamine with sebacic acid or dodecanedioic acid. In the numeral notation XY, X represents conventionally the number of carbon atoms originating from the diamine residues and Y represents the number of carbon atoms originating from the diacid residues.

According to one particular embodiment, the polyamide is selected from PA 9, PA 10, PA 11, PA 12, PA 610, PA 612, PA 614, PA 618, PA 1010 and PA 1012.

The polyamide in the composition according to the invention preferably has a melting point of less than or equal to 300° C. The polyamide preferably has a melting point of less than or equal to 250° C., more particularly 200° C., more particularly 190° C.

The polyamide in the pigmented pulverulent composition according to the invention possesses an inherent viscosity of greater than or equal to 0.7 (g/100 g)⁻¹. Moreover, the viscosity of the polyamide in the composition is advantageously less than or equal to 1.2 (g/100 g)⁻¹. Its inherent viscosity is preferably less than or equal to 1.1 (g/100 g)⁻¹, more particularly 1.0 (g/100 g)⁻¹, especially 0.9 (g/100 g)⁻¹, more preferably 0.8 (g/100 g)⁻¹. Beyond a viscosity of 1.2 (g/100 g)⁻¹, the composition becomes difficult to apply. A polyamide with a viscosity of between 0.8 and 1.0 (g/100 g)⁻¹ gives coatings with particularly advantageous properties.

The volume-median diameter Dv50 of the pigmented pulverulent composition according to the invention is from 30 to 200 μm, more particularly from 30 to 100 μm, and especially from 30 to 50 μm and more preferably 32 to 38 μm. The Dv50 of the pigmented pulverulent composition may be from 30 to 50 μm, or from 50 to 80 μm, or from 80 to 100 μm, or from 100 to 130 μm, or from 130 to 150 μm, or from 150 to 180 μm, or from 180 to 200 μm.

The one or more polyamides are preferably present in a quantity by mass, relative to the total mass of the pulverulent composition, of 40 to 99%, more preferably from 50 to 95%, more preferably still from 60 to 90%, as for example from 40 to 45%, or from 45 to 50%, or from 50 to 55%, or from 55 to 60%, or from 60 to 65%, or from 65 to 70%, or from 70 to 75%, or from 75 to 80%, or from 80 to 85%, or from 85 to 90%, or from 90% to 95%, or else from 95 to 99%.

The pigmented pulverulent composition according to the invention also comprises one or more pigments or dyes. These pigments or dyes are generally in pulverulent form.

The pigment may in principle be freely selected from the pigments used conventionally. It may in particular be selected from inorganic pigments like titanium dioxide, carbon black, cobalt oxide, nickel titanate, molybdenum bisulfide, aluminum flakes, iron oxides, zinc oxide, zinc phosphate, and organic pigments, such as phthalocyanine and anthraquinone derivatives.

The dye may also be of any type known to a person skilled in the art. Included more particularly are azo dyes, anthraquinonoid dyes, dyes derived from indigo, triarylmethane dyes, chlorine dyes and polymethine dyes.

The pigments and dyes are preferably present in a quantity by mass, relative to the total mass of the pulverulent composition, of 1 to 30%, more preferably from 2 to 10%, more preferably still from 3 to 5%, as for example from 0 to 5%, or from 5 to 10%, or from 10 to 15%, or from 15 to 20%, or from 20 to 25%, or from 25 to 30%.

The pigmented pulverulent composition according to the invention may further comprise where appropriate one or more additives selected from the group consisting of anti-crater agents or spreading agents, reducing agents, antioxidants, reinforcing fillers, UV stabilizers, fluidizing agents and corrosion inhibitors, or mixtures of these. These additives are advantageously in pulverulent form.

The reinforcing filler may be of any type that is suitable for preparing polyamide-based powders. However, it is preferable for the filler to be selected from the group consisting of talc, calcium carbonates, manganese carbonates, potassium silicates, aluminium silicates, dolomite, magnesium carbonates, quartz, boron nitride, kaolin, wollastonite, titanium dioxide, glass beads, mica, carbon black, mixtures of quartz, mica and chlorite, feldspar and dispersed nanometric fillers such as carbon nanotubes and silica. It may also comprise fibers, especially glass fibers and carbon fibers. In a particularly preferred manner, the filler is calcium carbonate.

The anti-crater agent and/or spreading agent may be of any type known to a person skilled in the art. Preferably, the anti-crater agent and/or spreading agent is selected from the group consisting of polyacrylate derivatives.

The UV stabilizer may be of any type known to a person skilled in the art. Preferably, the UV stabilizer is selected from the group consisting of resorcinol derivatives, benzotriazoles, phenyltriazines and salicylates.

The antioxidants may be of any type known to a person skilled in the art. Preferably, the antioxidants are selected from the group consisting of copper iodide combined with potassium iodide, phenol derivatives and hindered amines.

The fluidizing agent may be of any type known to a person skilled in the art. Preferably, the fluidizing agent is selected from the group consisting of aluminas and silicas.

The corrosion inhibitors may be of any type known to a person skilled in the art. Preferably, the corrosion inhibitors are selected from the group consisting of phosphosilicates and borosilicates.

The composition preferably comprises less than 10% by weight or is even essentially devoid of dulling agent.

These additives are preferably present in a quantity by mass, relative to the total mass of the pulverulent composition, of 0 to 50%, more preferably from 0 to 30%, more preferably still from 0 to 5%, as for example from 0 to 5%, or from 5 to 10%, or from 10 to 15%, or from 15 to 20%, or from 20 to 25%, or from 25 to 30%, or from 30 to 35%, or from 35 to 40%, or from 40 to 45%, or from 45 to 50%.

According to one embodiment, the pigmented pulverulent composition according to the invention consists essentially, or consists, of one or more polyamides, one or more pigments, and optionally one or more additives as described above.

The pigments and/or additives are advantageously mixed into the polyamide in the melt state. Such mixing may be carried out for example by compounding, especially in an extruder. The pigments and/or additives thus added are then in polyamide-clad form.

### B. Process for Manufacturing the Pulverulent Composition

The invention further concerns a process for preparing a pigmented pulverulent composition based on polyamide, comprising the steps of:
(i) mixing one or more pigments and optional additives with a polyamide in the melted state, the polyamide having an inherent viscosity of less than 0.6 (g/100 g)⁻¹;
(Ii) extruding the mixture obtained in step (i) to give an extrudate;
(iii) grinding the extrudate obtained in step (ii) to give a pulverulent composition; and
(iv) performing solid-phase polycondensation of the pulverulent composition obtained in step (iii) until the polyamide has an inherent viscosity of more than 0.8 (g/100 g)⁻¹.

The polyamide having an inherent viscosity of less than 0.6 (g/100 g)⁻¹ used in step (i) may be obtained by polycondensation of one or more monomers as described above in the presence of water and where appropriate a suitable catalyst.

The one or more monomers may be selected from amino acids such as aminocaproic, 7-aminoheptanoic, 11-aminoundecanoic and 12-aminododecanoic acid, and/or mixtures thereof, preferably 11-aminoundecanoic acid or one of the mixtures thereof.

They may also comprise a mixture of diamine monomers and diacid monomers, preferably a mixture of diamine monomers such as hexamethylenediamine, decanediamine, dodecamethylenediamine, meta-xylylenediamine, bis-p-aminocyclohexylmethane and trimethylhexamethylenediamine with diacid monomers such as isophthalic, terephthalic, adipic, azelaic, suberic, sebacic, dodecanedioic and tetradecanedioic acids, or one of the mixtures thereof.

According to one embodiment, water is added in an amount of 10% to 40%, preferably of 20% to 30% by weight relative to the total weight of the mixture. The water may be added to the mixture in the step of supplying, and/or during the polycondensation step.

The catalyst may be in particular a phosphorus-based acid such as phosphoric acid and/or phosphorous acid.

The polyamide synthesis reaction is known per se, and described in particular in Nylon Plastics Handbook, Ed. Melvin I. Kohan, Hanser Publishers 1995, pages 17 to 27.

The inherent viscosity of the polyamide used in step (i) of the process is less than 0.6 (g/100 g)⁻¹ and preferably within the range from 0.25 to 0.55, preferably between 0.3 and 0.4 (g/100 g)⁻¹.

Step (i) is advantageously carried out in a mixer with shearing, such as a single-screw or twin-screw extruder.

The one or more pigments and also the optional additives may be introduced into the mixer with the polyamide or subsequently. If the pigmented pulverulent composition comprises a plurality of pigments, they may be added in masterbatch form to aid homogenization. The masterbatch may in particular be made in the polyamide used in the composition.

The extrusion step (ii) may be carried out through a pelletizing dye to produce pellets. The volume-median diameter Dv50 of the pellets is advantageously within a range from 1 to 10 and more particularly from 2 to 4 mm. Extrusion may alternatively be carried out through a die to a cooled roll mill in which the mixture solidifies, or else using a calender. The solidified mixture may then be conveyed to a crusher to produce flakes. The average size of these flakes is typically 5×5×1 mm. Step (iii) is advantageously carried out in a mechanical grinding mill, and at ambient temperature, especially in an impact mill such as a hammer mill, a knife mill, a disk mill, or an air-jet mill. An agent that aids grinding, such as silica, preferably fumed silica, may be added to the polyamide prior to grinding.

This step may advantageously be carried out in a grinding mill equipped with an integrated selector. In that case, the desired particle size of the composition may be controlled directly by adjusting the grinding speed, the grinding speed being adjusted preferably by means of a selector integrated in the grinding mill.

Generally speaking, it may be useful to follow step (iii) with a step (iiia) of selecting the pulverulent composition obtained so as to adjust its particle size. The selection may be carried out for example by screening and/or classifying.

It is particularly advantageous to use a grinding mill equipped with an internal selector. The particle size of the pulverulent composition may be controlled by adjusting the grinding speed and also the speed of the selector integrated in the grinding mill.

The pulverulent composition obtained from step (iii) advantageously has where appropriate a volume-median diameter Dv50 of 30 to 200 μm, preferably of 30 to 50 μm, more particularly of 32 to 38 μm. The Dv50 of the pigmented pulverulent composition may be from 30 to 50 μm, or from 50 to 80 μm, from 80 to 100 μm, or from 100 to 130 μm, or from 130 to 150 μm, or from 150 to 180 μm, or from 180 to 200 μm.

The solid-phase polycondensation step (iv) may be carried out at a temperature above the glass transition temperature but below the melting point of the polyamide. The reaction is carried out advantageously in an inert atmosphere, under nitrogen or under vacuum, for example. The reaction time needed to attain the expected inherent viscosity depends on the temperature selected; it may be established by simple routine tests. This step may be carried out advantageously in a drier.

According to the invention, the polyamide in the pigmented pulverulent composition based on polyamide has an inherent viscosity of more than 0.7 (g/100 g)⁻¹. Advantageously, moreover, it is less than 1.2 (g/100 g)⁻¹. Its inherent viscosity is preferably less than or equal to 1.1 (g/100 g)⁻¹, more particularly 1.0 (g/100 g)⁻¹, especially 0.9 (g/100 g)⁻¹, more preferably 0.8 (g/100 g)⁻¹.

### C. Use for Coating a Substrate

The pigmented pulverulent composition based on polyamide according to the invention is useful especially for coating substrates, especially metallic substrates.

According to another aspect, the invention therefore concerns the use of the pigmented pulverulent composition based on polyamide as described above for coating a substrate.

The term “metallic substrate” refers to a substrate which comprises, consists essentially of or consists of one or more metals. The metallic substrate may be of any type. The metallic substrate may preferably be a part made of regular or galvanized steel, of aluminum or of aluminum alloy.

Before coating, the metallic substrate may have undergone one or more surface treatments that are well known to a person skilled in the art, such as coarse degreasing, alkaline degreasing, brushing, shot-blasting or sand-blasting, fine degreasing, hot rinsing, phosphating degreasing, iron/zinc/tri-cation phosphations, chromating, cold rinsing and chromic rinsing. Thus, the pigmented pulverulent composition may be used for coating treated or untreated metallic substrates.

Advantageously, the substrate intended to be coated is made of smooth or shot-blasted degreased steel, phosphated degreased steel, iron or zinc phosphated steel, Sendzimir galvanized steel, electro-galvanized steel, bath-galvanized steel, cataphoresis-treated steel, chromated steel, anodized steel, corundum sand-blasted steel, degreased aluminum, smooth or shot-blasted aluminum, chromated aluminum, cast iron and any other metal alloy.

The substrate may be coated totally or partly.

Preferably, the coating formed on the substrate is a film with a thickness of 100 to 550 μm, more preferentially of 100 to 300 μm. In embodiments, the film has a thickness of from 100 to 150 μm, or from 150 to 200 μm, or from 200 to 250 μm, or from 250 to 300 μm, or from 300 to 350 μm, or from 350 to 400 μm, or from 400 to 450 μm, or from 450 to 500 μm, or from 500 to 550 μm.

The coating on the substrate preferably has an inherent viscosity of greater than or equal to 0.7 (g/100 g)⁻¹. The inherent viscosity of the coating may be different from that of the pulverulent composition used to form it. The inherent viscosity of the coating may more particularly be greater owing to a resumption of the polycondensation under the conditions in which the coating is formed. In certain embodiments, the coating on the substrate has an inherent viscosity of greater than or equal to 0.8, greater than or equal to 0.85, or greater than or equal to 0.9, or greater than or equal to 0.95, or greater than or equal to 1.05, or greater than or equal to 1, or greater than or equal to 1.1, or greater than or equal to 1.15, or greater than or equal to 1.2, or greater than or equal to 1.25, or greater than or equal to 1.3. In the text above, the inherent viscosity is expressed in (g/100 g)⁻¹. Another subject of the invention is a process for coating a substrate, comprising the following steps:
contacting the substrate with the pigmented pulverulent composition based on polyamide as described above; and
melting the pulverulent composition under the effect of heat.

The pigmented pulverulent composition may be applied to or contacted with a substrate according to numerous techniques that are well known to a person skilled in the art. The coating is preferably carried out by electrostatic spraying or hot powder coating.

Alternatively, the coating may be carried out by electrostatic spraying.

The step of contacting the substrate with the pigmented pulverulent composition based on polyamide may in that case comprise the steps of:
electrically charging the pulverulent composition;
spraying the electrically charged pulverulent composition onto the substrate; and
heating the target substrate covered with pulverulent composition to a temperature above the melting point of the polyamide.

Coating by electrostatic spraying involves depositing electrostatically charged powder particles onto a substrate, especially at ambient temperature. The pulverulent composition may be electrostatically charged as it passes through the nozzle of spraying equipment. The composition thus charged can then be sprayed onto the substrate to be coated, which is connected to a zero potential. The coated substrate can then be placed in an oven at a temperature allowing melting of the composition to give a film.

The powder spraying equipment may be of any type—for example, an electrostatic gun which charges the powder by corona effect and/or by frictional electrification. Preferably, the nozzle is brought to a high potential of between about 10 and about 100 kV, of negative or positive polarity. Preferably, the powder flow rate in the spraying equipment is from 10 to 200 g/minute and more preferably from 50 to 120 g/minute. The electrostatic application temperature for the powder is preferably 15 to 25° C. The oven residence time for the substrate is preferably 3 to 15 minutes. The heating temperature of the substrate covered with powder may be at least 30° C. above, preferably from 30 to 60° C. above, the melting point of the polyamide. The substrate may then be cooled, to ambient temperature, for example.

According to another embodiment, the coating of the substrate is carried out by hot powder coating.

The step of contacting the substrate with the pigmented pulverulent composition in that case comprises the steps of:
heating the substrate to a temperature above the melting point of the polyamide;
spraying the pigmented pulverulent composition onto the substrate.

The substrate heating temperature may be as described above in relation with coating by immersion in a fluidized bed. The substrate may then be cooled, to ambient temperature, for example. The sprayed powder may or may not be electrostatically charged.

### D. Coated Objects Obtainable

According to another aspect, the invention concerns an object comprising a substrate covered with a coating obtainable by melting the pulverulent composition as described above. The coating, indeed, endows the object with effective protection against corrosion and abrasion.

This object is preferably intended:
for transferring fluids, notably in the form of piping, accessories, pumps or valves;
for automobiles, notably in the form of splined shafts, sliding door rails or springs; especially of truck damper or automobile seat type;
for wirework articles, notably in the form of dishwasher baskets or springs.

### BRIEF DESCRIPTION OF THE FIGURES

A better understanding of the invention will be obtained in the light of the description which follows and of the figures, which show:

FIG. 1 represents a scheme of the process of recycling the powder of examples 1 to 4, used for manufacturing films;

FIG. 2 represents a semi-logarithmic diagram of the volumetric particle size distribution (volume fraction as a function of size) of a powder as per example 1, measured using a Malvern Insitec laser granulometer (solid line: virgin powder; -o-: once-recycled powder; -□-: twice-recycled powder; -( )-: thrice-recycled powder);

FIG. 3 represents a semi-logarithmic diagram of the volumetric particle size distribution (volume fraction as a function of size) of a powder as per example 2, measured using a Malvern Insitec laser granulometer (solid line: virgin powder; -o-: once-recycled powder; -□-: twice-recycled powder; -( )-: thrice-recycled powder);

FIG. 4 represents a semi-logarithmic diagram of the volumetric particle size distribution (volume fraction as a function of size) of a powder as per example 3, measured using a Malvern Insitec laser granulometer (solid line: virgin powder; -o-: once-recycled powder; -□-: twice-recycled powder; -( )-: thrice-recycled powder);

FIG. 5 represents a semi-logarithmic diagram of the volumetric particle size distribution (volume fraction as a function of size) of a powder as per example 4, measured using a Malvern Insitec laser granulometer (solid line: virgin powder; -o-: once-recycled powder; -□-: twice-recycled powder; -( )-: thrice-recycled powder).

### EXAMPLES

### Example 1

A pigmented pulverulent composition based on polyamide was manufactured according to the process below.

To start with, a low-viscosity polyamide 11 was synthesized, called “prepolymer” hereinafter, from 1.2 kg of 11-aminoundecanoic acid in the presence of 0.5 kg of water, 5 g of hypophosphorous acid and 9.8 g of phosphoric acid. The mixture is heated to a temperature of 190° C. in 2 h with stirring when the temperature reaches 160° C. or the pressure exceeds 8.5 bar. During the synthesis, the water initially charged with 11-aminoundecanoic acid is removed by evaporation at constant pressure (p=10 bar). Following withdrawal of an amount of water of 430 g, the melted prepolymer is extruded using a twin-screw extruder. The mixture is then cooled via two steel rolls with circulation of cold water for solidification, cooled and crushed to flakes.

The resulting prepolymer, having a viscosity of 0.35, is mixed in a suitable vessel with a formulation of additives comprising antioxidants and spreading agents and a white pigment based on titanium dioxide in the proportions indicated in table 1 below.

This mixture is introduced into a twin-screw extruder, to be melted and intimately mixed, and then extruded. The mixture is then cooled via two steel rolls with circulation of cold water for solidification, cooled and then crushed to flakes.

The pigmented and additized prepolymer recovered in the form of flakes is then ground in a hammer mill equipped with an internal selector, to give a powder having a volume-median diameter Dv50, as measured according to ISO 9276—parts 1 to 6, of 35 μm.

The ground powder then undergoes solid-phase polycondensation in a drier at 140-152° C. under vacuum in order to increase the viscosity of the polyamide to 0.93 (g/100 g)⁻¹.

TABLE 1

| Composition | Example 1 | Example 2 | Example 3 | Example 4 |
|---|---|---|---|---|
| Polyamide 11 | 88.9 | 88.9 | 87.4 | 87.4 |
| Hypophosphorous acid | 0.3 | 0.3 | 0.7 | 0.7 |
| Phosphoric acid | 0.7 | 0.7 | — | — |
| Formulation of additives | 1.2 | 1.2 | 1.3 | 1.3 |
| Blue pigment | — | — | 1.0 | 1.0 |
| Black pigment | — | — | 0.1 | 0.1 |
| White pigment | 8.9 | 8.9 | 9.6 | 9.6 |
| Total: | 100.0 | 100.0 | 100.0 | 100.0 |

### Composition of the Pigmented Pulverulent Compositions

### Example 2 (Comparative Example to Example 1)

For comparison, a pigmented pulverulent composition based on polyamide was manufactured according to the process below.

The prepolymer obtained by the process indicated in example 1 in the form of flakes is then ground in a hammer mill equipped with an internal selector, to give a powder having a volume-median diameter Dv50, as measured according to ISO 9276—parts 1 to 6, of 35 μm.

The ground prepolymer then undergoes solid-phase polycondensation at 140-152° C. under vacuum in order to increase the viscosity of the polyamide to 0.93 (g/100 g)⁻¹.

Lastly, the pulverulent polyamide 11 is mixed in a Henschel rapid mixer for 120 seconds at 1800 revolutions/minute, at ambient temperature (between 15 and 50° C.) with the additives formulation and a white pigment based on titanium dioxide in the proportions indicated in table 1 above.

### Example 3

A pigmented pulverulent composition based on polyamide was manufactured according to the process below.

To start with, a low-viscosity polyamide 11 was synthesized, called “prepolymer” hereinafter, from 1.2 kg of 11-aminoundecanoic acid in the presence of 0.5 kg of water and 9.5 g of hypophosphorous acid. The mixture is heated to a temperature of 190° C. in 2 h with stirring when the temperature reaches 160° C. or the pressure exceeds 8.5 bar. During the synthesis, the water initially charged with 11-aminoundecanoic acid is removed by evaporation at constant pressure (p=10 bar). Following withdrawal of an amount of water of 430 g, the melted prepolymer is extruded using a twin-screw extruder. The mixture is then cooled via two steel rolls with circulation of cold water for solidification, cooled and crushed to flakes.

The resulting prepolymer is mixed in a suitable vessel with a formulation of additives, a white pigment based on titanium dioxide, a blue pigment based on cobalt salt and a black pigment of carbon black type in the proportions indicated in table 1 above.

This mixture is introduced into a twin-screw extruder, to be melted and intimately mixed, and then extruded. The mixture is then cooled via two steel rolls with circulation of cold water for solidification, cooled and then crushed to flakes.

The pigmented and additized prepolymer recovered in the form of flakes is then ground in a hammer mill equipped with an internal selector, to give a powder having a volume-median diameter Dv50, as measured according to ISO 9276—parts 1 to 6, of 35 μm.

The ground powder then undergoes solid-phase polycondensation in a drier at 140-152° C. under vacuum in order to increase the viscosity of the polyamide to 0.93 (g/100 g)⁻¹.

### Example 4 (Comparative Example to Example 3)

For comparison, a pigmented pulverulent composition based on polyamide was manufactured according to the process below.

The prepolymer obtained by the process indicated in example 1 in the form of flakes is ground in a hammer mill equipped with an internal selector, to give a powder having a volume-median diameter Dv50, as measured according to standard ISO 9276—parts 1 to 6, of 35 μm.

The ground prepolymer then undergoes solid-phase polycondensation at 140-152° C. under vacuum in order to increase the viscosity of the polyamide to 0.93 (g/100 g)⁻¹.

Lastly, the pulverulent polyamide 11 is mixed in a Henschel rapid mixer for 120 seconds at 1800 revolutions/minute, at ambient temperature (between 15 and 50° C.) with a formulation of additives, a white pigment based on titanium dioxide, a blue pigment based on cobalt salt and a black pigment of carbon black type in the proportions indicated in table 1 above.

### Production of Coatings

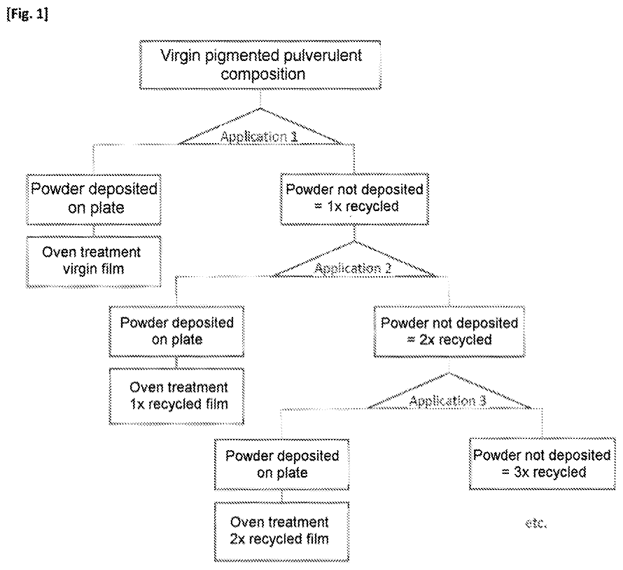

To compare the performance properties of the pigmented pulverulent compositions over the course of the recycling procedures, the virgin powder prepared in the examples above was used to manufacture a first film (virgin film), after which the excess powder was recovered three times in succession to manufacture recycled films, according to the protocol detailed in FIG. 1.

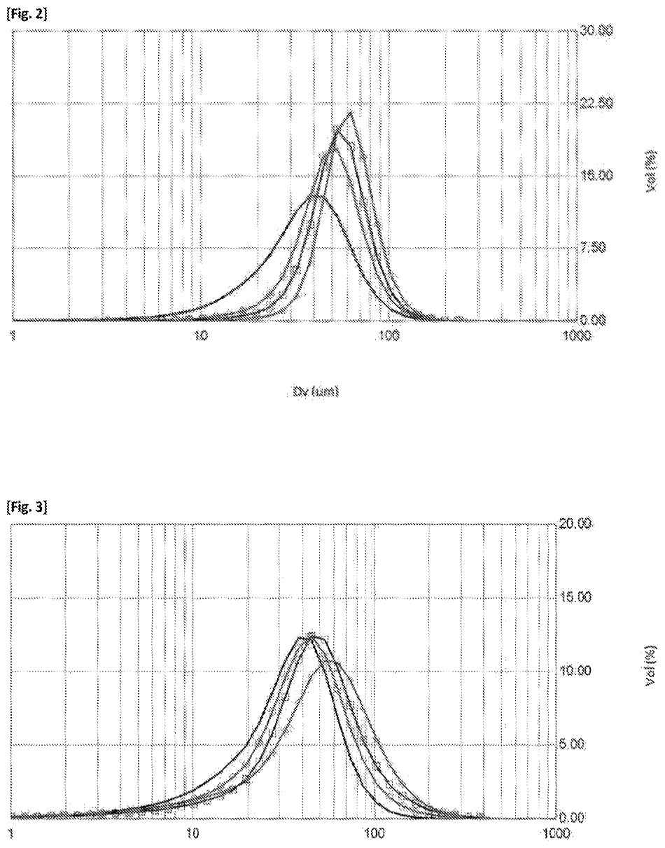

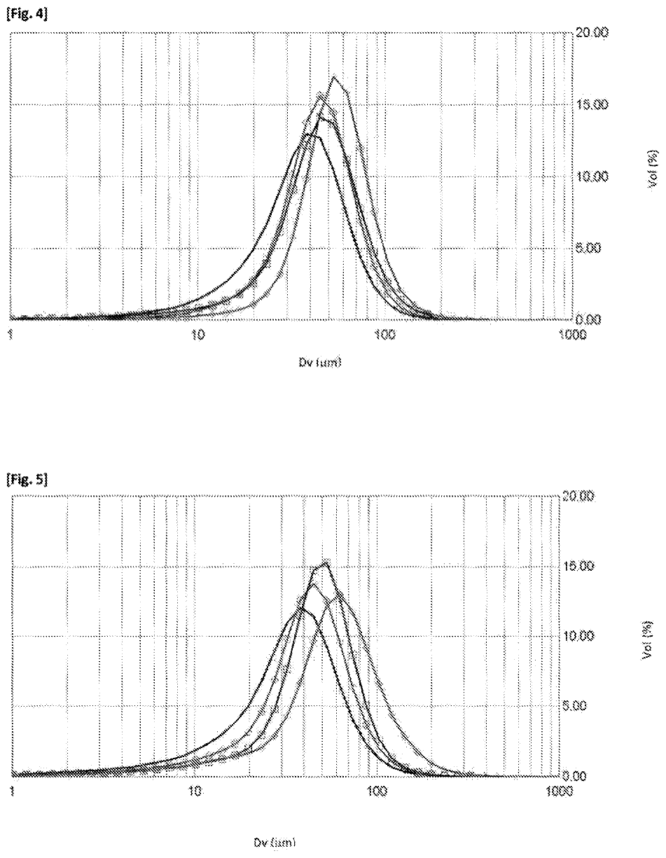

First of all, the virgin and recycled powders were characterized by measurement of the particle size by volume (see FIG. 2 to 5) and of Dv10, Dv50 and Dv90, as measured according to standard ISO 9276—parts 1 to 6, by means of a laser granulometer (Malvern Système Insitec) and the associated software (RT sizer). The particle size distributions obtained for the powders are illustrated in FIG. 2 to FIG. 5. The values of Dv10, Dv50 et Dv90 plotted on these curves are collated in table 2 below.

On the basis of these results, a gradual evolution is observed in the particle size of the powders over the course of their recycling. This is because the extraction of air in the spray booth entrains a portion of the fine particles of the powder. It is also seen that the Dv90 of the powder of example 2 increases markedly more than that of the powder of example 1 and that the Dv90 of the powder of example 4 increases markedly more than that of the powder of example 3.

The particle size curves (FIG. 2 to FIG. 5) demonstrate, moreover, that the maximum diameters of the powders of examples 1 and 3 remain essentially stable at around 200 μm, whereas they increase for the powders of examples 2 and 4 to more than 300 μm on the third recycling, which is indicative of agglomeration of the particles. Because of their weight, the large-size particles have more of a tendency to detach from the metallic base before traversing the oven, which makes it more difficult to apply the powders of examples 2 and 4. Furthermore, these particles take longer to coalesce, which thus affects film formation.

TABLE 2

| | Dv10 | Dv50 | Dv90 | Dv10 | Dv50 | Dv90 |
|---|---|---|---|---|---|---|
| Example | [μm] | [μm] | [μm] | [μm] | [μm] | [μm] |
| | Virgin powder | | | Recycled powder 1 | | |
| 1 | 13.9 | 33.6 | 60.7 | 25.6 | 45.2 | 71.9 |
| 2 | 10.4 | 33.0 | 66.8 | 12.8 | 37.3 | 73.0 |
| 3 | 13.5 | 34.0 | 61.1 | 20.2 | 40.6 | 68.9 |
| 4 | 10.0 | 32.2 | 61.6 | 13.8 | 38.4 | 68.9 |
| | Recycled powder 2 | | | Recycled powder 3 | | |
| 1 | 31.3 | 50.1 | 76.9 | 37.1 | 55.9 | 84.1 |
| 2 | 37.1 | 55.9 | 84.1 | 15.0 | 54.6 | 135.0 |
| 3 | 25.8 | 46.0 | 75.7 | 30.9 | 51.7 | 85.3 |
| 4 | 18.0 | 43.9 | 77.8 | 17.8 | 53.9 | 107.3 |

### Evolution of the Particle Size of the Pulverulent Composition

The films were manufactured by application of the powder using an electrostatic gun (positive corona, +35 to +45 kV, 10 to 30 μA) to metal plates of steel 3 mm thick, treated with a nonstick treatment (silicone coating), making it easier subsequently to detach the coating films. The metal plates thus powder-coated were then heat-treated (oven at 220° C. for 10 minutes), so as to melt the powder and to give a film. The films are then detached from the substrates and characterized in terms of appearance and of mechanical properties.

The films were characterized as to film color on an Insitec spectrophotometer from Malvern by means of their coordinates L*, a*, b* and the hue difference dE*, according to standard ISO 18314. Furthermore, their 60° gloss was determined using a Byk micro-Tri-Gloss glossmeter according to standard ISO 2813. Lastly, the appearance of the films was inspected visually, and they were classed as follows: (+)=regular and glossy appearance; (−)=irregular and satiny appearance, some craters; (− −)=irregular and satiny appearance, many craters.

The results of these measurements and evaluations are collated in table 3 below.

It is noted that even before any recycling, the appearance of the film resulting from the powder of example 1 is much more regular and glossy than that of example 2. The same is true of the film resulting from the powder of example 3, which is also much more regular and glossy than that of example 3. After recycling, the films obtained from the powder of example 1 and those obtained from the powder of example 3 exhibit gloss levels which are high and virtually unchanged irrespective of the number of times they are recycled. In contrast, the films obtained from the powder resulting from example 2 and those obtained from the powder resulting from example 4 see their gloss diminished over the course of repeated recycling, this being manifested in greater surface roughness and poorer film formation. This observation may be linked to the presence of large-size particles, which coalesce less ideally. Likewise observed is an evolution in the number of craters over the course of repeated recycling for the powders of examples 2 and 4, by contrast with the powders of examples 1 and 3.

The films were manufactured by application of the powder using an electrostatic gun (positive corona, +35 to +45 kV, 10 to 30 μA) to metal plates of steel 3 mm thick, treated with a nonstick treatment (silicone coating), making it easier subsequently to detach the coating films. The metal plates thus powder-coated were then heat-treated (oven at 220° C. for 10 minutes), so as to melt the powder and to give a film. The films are then detached from the substrates and characterized in terms of appearance and of mechanical properties.

The results of these measurements and evaluations are collated in table 3 below.

Furthermore, it is noted that over the course of repeated recycling, the variation in hue dE* is greater for the films obtained with the powder of examples 2 and 4 as compared, respectively, with those obtained with the powders of examples 1 and 3. This observation is considered to convey a better retention of hue for the powders of examples 1 and 3, in which the pigments are encapsulated.

Lastly, the mechanical properties of the films obtained were evaluated by means of the elongation at break, using a Zwick BZ1 dynamometer from Instron according to standard ISO 527-3.

To aid with the comparison of the results, a calculation was made of the relative elongation at break Aᵣₑᵢ resulting from the ratio of the elongation at break of the evaluated coating, Aₜₑₛₜ, to that of the coating obtained from the powder of example 1, A_{ref}:

$$Arel = \frac{Atest}{Aref} \times 10 \qquad [ Math . 1 ]$$

The results of these measurements are collated in table 4 below.

It is noted that over the course of repeated recycling, the films obtained with the powder of examples 1 and 3 have higher and more stable elongations at break as compared with those resulting from the powders of examples 2 and 4. The distance of the initial elongation at break between the two types of films thus increases with repeated recycling. A better elongation at break is considered to reflect improved dispersion of the additives and pigments in the powder. The powders of examples 1 and 3 hence result in more regular and more flexible films.

TABLE 3

| | Color | | | | 60° | Appear- | Color | | | | 60° | Appear- |
|---|---|---|---|---|---|---|---|---|---|---|---|---|
| Example | L* | a* | b* | dE* | gloss | ance | L* | a* | b* | dE* | gloss | ance |
| | Virgin powder film | | | | | | 1x-recycled powder film | | | | | |
| Example 1 | 96.0 | 0.8 | 1.2 | — | 70 | + | 95.8 | 0.8 | 1.0 | 0.3 | 77 | + |
| Example 2 | 92.4 | −1.1 | 1.9 | — | 44 | − | 90.5 | −1.1 | 1.0 | 2.1 | 45 | − |
| Example 3 | 64.0 | −2.1 | −2.5 | — | 84 | + | 64.0 | −2.1 | −2.5 | 0.1 | 84 | + |
| Example 4 | 58.5 | −2.3 | −3.6 | — | 48 | − | 56.1 | −2.3 | −3.6 | 2.4 | 37 | − |
| | 2x-recycled powder film | | | | | | 3x-recycled powder film | | | | | |
| Example 1 | 95.8 | 0.8 | 1.1 | 0.2 | 75 | + | 95.5 | 0.8 | 0.7 | 0.7 | 77 | + |
| Example 2 | 89.1 | −1.1 | 1.0 | 3.5 | 28 | −− | 88.1 | −1.0 | 0.9 | 4.4 | 20 | −− |
| Example 3 | 64.0 | −2.1 | −2.6 | 0.1 | 82 | + | 64.0 | −2.1 | −2.5 | 0.1 | 86 | + |
| Example 4 | 56.9 | −2.3 | −3.8 | 1.5 | 32 | − | 27.1 | −2.4 | −4.0 | 1.4 | 24 | − |

### Appearance of the Films Obtained, in Terms of Color, Gloss and Visual Appearance

TABLE 4

| | Virgin powder | 1×-recycled | 2×-recycled | 3×-recycled |
|---|---|---|---|---|
| | film | powder film | powder film | powder film |
| Example | Aᵣₑₗ* (%) | Aᵣₑₗ* (%) | Aᵣₑₗ* (%) | Aᵣₑₗ* (%) |
| Example 1 | 10.0 | 9.8 | 9.4 | 8.9 |
| Example 2 | 7.7 | 7.2 | 6.8 | 5.3 |
| Example 3 | 10.0 | 9.3 | 9.7 | 8.9 |
| Example 4 | 0.7 | 0.6 | 0.4 | 0.3 |

### Elongation at Break of the Films Obtained

The tests carried out clearly demonstrate that it is possible to recycle a powder in which the pigments are encapsulated in the polyamide. The reason is that this recycled powder can be used to obtain films having highly consistent optical and mechanical properties, by contrast with a powder in which the pigments and additives are simply dry-mixed.

1. A pigmented pulverulent composition based on polyamide for coating substrates, comprising:
(a) 40% to 99% by weight of at least one polyamide,
(b) 1% to 30% by weight of at least one pigment, and
(c) 0% to 30% by weight of at least one additive,
wherein the pigment and the optional additive are added to the polyamide in the melted state; the polyamide has an inherent viscosity, as measured using an Ubbelohde tube at 20° C. on a 0.5% by weight solution in m-cresol according to standard ISO 307 but with a measuring temperature of 20° C. rather than 25° C., of more than 0.7 (g/100 g)⁻¹, and wherein the composition has a volume-median diameter Dv50, as measured according to standard ISO 9276—parts 1 to 6, of 30 to 200 μm.

2. The composition as claimed in claim 1, wherein the polyamide is selected from PA 9, PA 10, PA 11, PA 12, PA 610, PA 612, PA 614, PA 618, PA 1010 and PA 1012.

3. The composition as claimed in claim 1, wherein the polyamide is a polyamide 11.

4. The composition as claimed in claim 1, wherein the pigment is selected from titanium dioxide, carbon black, cobalt oxide, nickel titanate, molybdenum bisulfide, aluminum flakes, iron oxides, zinc oxide, zinc phosphate, and organic pigments.

5. The composition as claimed in claim 1, comprising 50% to 95% by weight of at least one polyamide.

6. The composition as claimed in claim 1, comprising 1% to 30% by weight of at least one additive selected from anti-crater agents, spreading agents, reducing agents, antioxidants, reinforcing fillers, UV stabilizers, fluidizing agents and corrosion inhibitors.

7. The composition as claimed in claim 1, wherein the polyamide has an inherent viscosity, as measured using an Ubbelohde tube at 20° C. on a 0.5% by weight solution in m-cresol according to standard ISO 307 but with a measuring temperature of 20° C. rather than 25° C., of less than 1.0 (g/100 g)⁻¹.

8. A process for manufacturing a pigmented pulverulent composition as claimed in claim 1, comprising the steps of:
(i) mixing one or more pigments and optional additives with a polyamide in the melted state, the polyamide having an inherent viscosity of less than 0.6 (g/100 g)⁻¹;
(ii) extruding the mixture obtained in step (i) to give an extrudate;
(iii) grinding the extrudate obtained in step (ii) to give a pulverulent composition; and
(iv) performing solid-phase polycondensation of the pulverulent composition obtained in step (iii) until the polyamide in the composition has an inherent viscosity of more than 0.8 (g/100 g)⁻¹.

9. The process as claimed in claim 8, wherein the polyamide used in step (i) has an inherent viscosity of less than 0.4 (g/100 g)⁻¹.

10. The process as claimed in claim 8, wherein step (ii) is carried out in a single-screw extruder or a twin-screw extruder.

11. The process as claimed in claim 8, wherein step (iv) is carried out in a drier.

12. The use of the pigmented pulverulent composition as claimed in claim 1 for coating a substrate, especially a metallic substrate.

13. The use as claimed in claim 12, wherein the coating is carried out by electrostatic spraying or hot powder coating.

14. An object comprising a metallic substrate coated with a coating obtained with the pigmented pulverulent composition as claimed in claim 1.

15. The object as claimed in claim 14, wherein it is a piping, an accessory, a pump or a valve, a splined shaft, a sliding door rail or springs, especially of truck damper or automobile seat type, or else a dishwasher basket or springs.
